(19) United States
(12) Patent Application Publication
(10) Pub. No.: US 2026/0065209 A1
(43) Pub. Date: Mar. 5, 2026

(54) ENHANCED INCIDENT TRACKING, ANALYTICS, AND REMEDIATION

(71) Applicant: Honeywell International Inc., Charlotte, NC (US)

(72) Inventors: Mark Cockburn, Collaroy Plateau (AU); Rhys Crabb, Newport (AU); Jyotsana Jyotsana, Bangalore (IN)

(21) Appl. No.: 18/821,918

(22) Filed: Aug. 30, 2024

(51) Int. Cl. G06Q 10/0639; G06Q 10/0631

(52) U.S. Cl. CPC G06Q 10/06393; G06Q 10/06316

(57) ABSTRACT

A method comprises receiving, by a computing device of an incident management system, information associated with a plurality of incidents at a site for a time period; generating, by the computing device, a graphical user interface, the graphical user interface including visual representations of: the information associated with the plurality of incidents at the site, where the visual representations included visual representations of a plurality of closed incidents, real-time visual representations of a plurality of open incidents, or both; and operator performance metrics associated with the plurality of closed incidents and the plurality of open incidents; and identifying, by the computing device, a remediation action based on the information associated with the plurality of incidents at the site, the operator performance metrics, or both.

### TECHNICAL FIELD

The present disclosure relates systems, devices, and methods for enhanced incident tracking, analytics, and remediation.

### BACKGROUND

Industrial process control and automation systems are often used to automate large and complex industrial processes. These types of systems routinely include sensors, actuators, and controllers. The controllers are often arranged hierarchically in a control and automation system. For example, lower-level controllers are often used to receive measurements from the sensors and perform process control operations to generate control signals for the actuators. Higher-level controllers are often used to perform higher-level functions, such as planning, scheduling, and optimization operations. Human process operators routinely interact with controllers and other devices in a control and automation system, such as to review warnings, alarms, or other notifications, and adjust control or other operations to keep the process within desired process limits. When a process operator responds incorrectly and/or with an undue amount of delay to an alarm, warning or other process condition indicative of an occurrence of an incident, the overall efficiency of a plant may deteriorate. If not properly managed, an incident could escalate into an emergency, crisis, and/or disaster.

Incident management can refer to the process of limiting the potential disruption and/or loss caused by an incident (e.g., a security incident), and returning the organization's operations, services, and/or functions to normal (e.g., returning to business as usual). An incident management system may include standard operating procedures that can be used to manage incidents. A standard operating procedure may include a number of steps for a user to follow, such as, for instance, a sequence of actions to take, during an incident. Different standard operating procedures may be used to manage different types of incidents.

An incident management system may store information about incidents and/or the standard operating procedures used to manage those incidents such as, for instance, the steps of the standard operating procedures that have been executed by an operator during incidents, comments entered by the operator while executing the steps, and/or the status of the incidents.

### SUMMARY

The present disclosure relates generally to systems, devices, and methods for enhanced (e.g., automatic) incident tracking, analytics (e.g., contextualization) and remediation (e.g., resolution) related to an industrial process control and automation system.

As used herein, an incident can include and/or refer to a security incident, which can be any type of event that could lead to loss of, and/or disruption to, an organization's operations, services, and/or functions. Examples of incidents include a fire, door forced, bomb threat, terrorist attack, or severe weather. However, embodiments of the present disclosure are not limited to these examples. The incidents may occur at a site. For instance, a site can be a single building or facility, a plurality (e.g., group) of buildings, an area (e.g., room(s), space(s), zone(s), etc.) within a building or facility, or a campus of an organization. Embodiments of the present disclosure are not limited to these examples.

A particular example of the present disclosure includes an illustrative method for enhanced incident management, the method comprising: receiving, by a computing device of an incident management system, information associated with a plurality of incidents at a site for a time period; generating, by the computing device, a graphical user interface, the graphical user interface including visual representations of: the information associated with the plurality of incidents at the site, wherein the visual representations included visual representations of a plurality of closed incidents, real-time visual representations of a plurality of open incidents, or both; and operator performance metrics associated with the plurality of closed incidents and the plurality of open incidents; and identifying, by the computing device, a remediation action based on the information associated with the plurality of incidents at the site, the operator performance metrics, or both.

Another example of the present disclosure includes a computing device for enhanced incident management, the computing device comprising: a display; a memory; and a processor configured to execute executable non-transitory computer readable instructions stored in the memory to: receive, information associated a plurality of incidents at a site for a time period; generate a graphical user interface that is configured to be displayed via the display, the graphical user interface including visual representations of: the information associated with the plurality of incidents at the site, wherein the visual representations included representations of a plurality of closed incidents and real-time representations of a plurality of open incidents; and operator performance metrics associated with the plurality of closed incidents and the plurality of open incidents; and identify a remediation action based on the information associated with the plurality of incidents at the site, the operator performance metrics, or both.

Another example of the present disclosure includes a non-transitory, computer-readable medium including instructions that when executed by a processor cause the processor to receive, information associated a plurality of incidents at a site for a time period; generate a graphical user interface that is configured to be displayed via the display, the graphical user interface including visual representations of: the information associated with the plurality of incidents at the site, wherein the visual representations included representations of a plurality of closed incidents and real-time representations of a plurality of open incidents; and operator performance metrics associated with the plurality of closed incidents and the plurality of open incidents; identify a remediation action based on the information associated with the plurality of incidents at the site, the operator performance metrics, or both; and automatically initiate the remediation action.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative industrial process control and automation system;

FIG. 2 is an example computing device for enhanced incident tracking, analytics, and remediation;

FIG. 3 is an example of a graphical user interface for enhanced incident tracking, analytics, and remediation;

FIG. 4 is an example of a graphical user interface for enhanced incident tracking, analytics, and remediation;

FIG. 5 is a flow diagram showing an illustrative method for enhanced incident tracking, analytics, and remediation; and

FIG. 6 is a flow diagram showing an illustrative method for enhanced incident tracking, analytics, and remediation.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

It will be appreciated that industrial process control and automation systems require maintenance and upkeep, as well as rapid and effective responses to incidents in an industrial plant (e.g., as indicated by various alarms and warnings) to maintain the industrial plant in an efficient, safe and productive environment. Various personnel such as process operators, system maintenance engineers, control engineers, field engineers, technicians may make decisions and perform maintenance and/or remediation actions to ensure the industrial process control and automation systems run under normal operating conditions. Managing a large workforce of individuals and technicians is important for the efficient operation of industrial process, control, and automation systems within an industrial plant. Due to the development of technology, it is important for the workforce and personnel who oversee an industrial plant to continually update their skill set in order to efficiently operate new equipment and the like. Similarly, due to the occurrence of systematic incidents and/or occurrence of unforeseen incidents at a site it is desired to quantify responsiveness and/or a quantity of resolved incidents and open incidents.

Thus, the timely and effective management of incidents and returning building operations to normal conditions is a vital activity. Typically, standard operating procedures (e.g., standardized workflows) are deployed in the case of an occurrence of a particular type of incident. For example, each type of incident may have a corresponding standardized workflow. The use of the standardized workflows (e.g., which are implemented by operators, technicians, etc.) seeks to ensure that the response to each incident is handled timely, consistently, and effectively. However, there may be variation (e.g., between different sites, between different operators, etc.) with implementing the standardized workflow. Moreover, readily quantifying various types of incidents and the effectiveness of the corresponding remediation actions associated therewith may be a cumbersome and difficult process, particularly when the incidents occur at multiple different sites and/or when incidents are addressed by different operators.

As such, the systems, device, and methods herein provide enhanced incident tracking, analytics, and remediation. For instance, the systems, devices, and methods herein permit readily quantifying incidents (e.g., different incident types) and/or a quality of incident responses (e.g., in terms of a quantity of open and/or closed incidents, for instance, on a per site and/or per operator basis, etc.). That is, the systems, devices, and method herein permit enhanced management of sites such as permitting site managers to monitor incident response quality as well as a quantity of incident occurrences across multiple dimensions (such as operator, location, type, time). Additionally, in some embodiments the systems, devices, and methods herein permit the display of real-time operator performance metrics and/or permit the display of real-time status of any past, present, or needed remediations associated with the incidents.

Thus, the systems, devices, and methods herein can yield improved functioning of various devices and individuals (e.g., operators) associated with one or more sites, as detailed herein. For instance, the systems, devices, and methods herein permit the display of graphical user interfaces (in the form of live dashboards displaying various real-time information, as detailed herein). Operator performance can therefore be quantified and evaluated in various manners which were not previously possible with legacy dashboards or other approaches. For instance, the systems, methods, and devices herein can yield real-time key metrics (e.g., a quantity, a type, and/or a degree of real-time operator responsiveness to both real-time open incidents and closed incidents over a period of time). Moreover, the approaches herein yield enhanced (e.g., timely, consistent, and effective) incident resolution. For example, a low priority incident that remains open (is not remediated) for a relatively long amount of time can be automatically changed to a higher priority (e.g., resulting in more alarms/increased responsiveness to the open incident). The resultant benefits (e.g., improved visualization of a type and/or quantity of closed events and real-time (open) events (e.g., visualizing both at the same time via the dashboard) along with related operator performance, improved responsiveness to incidents, and/or enhanced operator effectiveness/performance evaluation (e.g., KPIs/performance can be determined based on a quantity, type, and/or incident location, etc.), training operators on specific areas for improvement (e.g., as identified based on the KPIs), and/or and automatic identification of remediation actions (e.g., operator training, adding operators, altering standard operating procedures for response to incidents, changing a type/quantity of alarms, altering a priority associated with an incident, etc.) can yield safer and more effective building management and thereby can improve the efficiency and operation of various components (e.g., equipment) in the site.

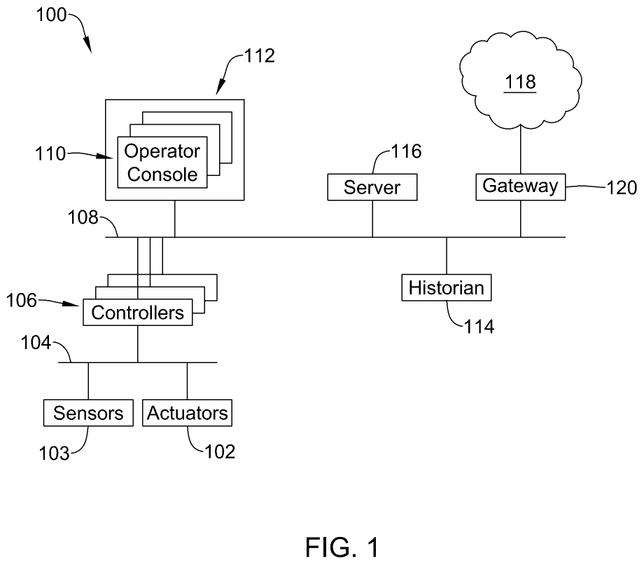

FIG. 1 provides a schematic block diagram showing an illustrative industrial process control and automation system 100. The system 100 includes various components that facilitate production or processing of at least one product or other material. For instance, the system 100 can be used to facilitate control over components in one or multiple industrial plants. The industrial plants may be one or more processing facilities (or one or more portions thereof), such as one or more manufacturing facilities for producing at least one product or other material. In general, the industrial plants may implement one or more industrial processes and can individually or collectively be referred to as a process system. A process system generally represents any system or portion thereof configured to process one or more products or other materials in some manner.

The system 100 includes one or more sensors 103 and one or more actuators 102. The sensors 103 and the actuators 102 represent components in a process system that may perform any of a wide variety of functions. In certain embodiments, sensors 103 and actuators 102 can correspond to equipment that is controlled by the automation system. That is, the sensors 103 and actuators 102 represent components in the industrial plant that perform any of a wide variety of functions. For example, sensors and actuators can measure various characteristics of the process system as well as alter any number of characteristics in the process system of the industrial plant represented by the system 100. The sensors 103 and actuators 102 can be automatically controlled by the process system of the industrial plant, manually controlled, or a combination thereof. The control and manipulation of the sensors 103 by the personnel or the process system of the industrial plant, or the combination thereof can be recorded by the historian, discussed in further detail below. For example, each time the sensors 103 and actuators 102 are adjusted, a record is created within the historian. The sensors 103 may measure a wide variety of characteristics in the process system, such as but not limited to temperature, pressure, flow rate, chemical concentrations, or a voltage transmitted through an electrical conductor. The actuators 102 may represent devices that are configured to alter a wide variety of characteristics in the process system. As an example, the actuators 102 may open or close one or more valves, or increase or decrease a process set point or the like. At any rate, each sensor 103 may include any suitable structure for measuring one or more characteristics in a process system. Each actuator 102 may include any suitable structure for operating on or affecting one or more conditions of a process system.

In the example shown, a network 104 is coupled to the sensors 103 and the actuators 102. The network 104 facilitates interaction with the sensors 103 and the actuator 102. For example, the network 104 may transmit measurement data from the sensors 103 and/or may provide control signals to the actuator 102. The network 104 may represent any suitable network or combination of networks. As particular examples, the network 104 could represent at least one Ethernet network (such as one supporting a FOUNDATION FIELDBUS protocol), electrical signal network (such as a HART network), Ethernet network, pneumatic control signal network, or any other or additional type(s) of network(s), or any other type of communication path.

The illustrative system 100 also includes various controllers 106. The controllers 106 may, for example, be used in the system 100 to perform various functions in order to control one or more industrial processes. To illustrate, a first set of controllers 106 may use measurements from one or more of the sensors 103 to control the operation of one or more of the actuators 102. A controller 18 may receive measurement data from one or more sensors 103 and use the measurement data to generate control signals for one or more actuators 102. A second set of controllers 106 may be used to optimize the control logic or other operations performed by the first set of controllers. A third set of controllers 106 could be used to perform additional functions. The controllers 106 could therefore support a combination of approaches, such as regulatory control, advanced regulatory control, supervisory control, and advanced process control.

Each of the controllers 106 may include any suitable structure for controlling one or more aspects of an industrial process. At least some of the controllers 106 may, for example, represent proportional-integral-derivative (PID) controllers or multivariable controllers, such as controllers implementing model predictive control (MPC) or other advanced predictive control (APC). As a particular example, each controller of the controllers 106 may represent a computing device running a real-time operating system, a WINDOWS operating system, or other operating system.

In the illustrative system 100, at least one network 108 couples to the controllers 106 and the other devices in the system 100. The network 108 facilitates communication of information between components. The network 108 may represent any suitable network or combination of networks. For example, the network 108 could represent an Ethernet network or any other suitable communication path.

Operator access to and interaction with the controllers 106 and other components of the system 100 can occur via various operator consoles 110. Each operator console 110 may be used to provide information to an operator and receive information from an operator. For example, each operator console 110 may provide information identifying a current state of an industrial process to the operator, such as values of various process variables and warnings, alarms, or other states associated with the industrial process. Each operator console of the operator consoles 110 may also receive information affecting how the industrial process is controlled, such as by receiving set points or control modes for process variables controlled by the controllers 106 or other information that alters or affects how the controllers 106 control the industrial process. Each operator console 110 may include any suitable structure for displaying information to and interacting with an operator. For example, each operator console 110 may represent a computing device running a WINDOWS operating system or other operating system. In some embodiments, the operator console 110 can be configured to display the incident dashboards described herein. Alternatively or additionally, incident dashboards described herein can be displayed elsewhere, for instance, at a console associated with a supervisor or other personal associated with the industrial plant.

Multiple operator consoles 110 may be grouped together and used in one or more control rooms 112. Each control room 112 may include any number of operator consoles 110 in any suitable arrangement. In some cases, multiple control rooms 112 may be used to control an industrial plant, such as when each control room 112 contains operator consoles 110 used to manage a discrete part of the industrial process/plant.

The illustrative system 100 also includes one or more servers 116. Each server 116 denotes a computing device that executes applications for users of the operator consoles 110 or other applications. The applications could be used to support various functions for the operator consoles 110, the controllers 106, or other components of the system 100. The servers 116 may be located locally or remotely from the illustrative system 100. For instance, the functionality of the server 116 could be implemented in a computing cloud or a remote server communicatively coupled to the system 100 via a gateway such as gateway 120. Each server 116 may represent a computing device running a WINDOWS operating system or other operating system. Note that while shown as being local within the system 100, the functionality of the server 116 may be remote from the system 100. For instance, the functionality of the server 116 may be implemented in a cloud-based server 118 or a remote server communicatively coupled to the system 100 via the gateway 120.

The control and automation system 100 here also includes at least one historian 114. The historian 114 represents a component that stores various information about the system 100. The historian 114 could, for instance, store information that is generated by the various controllers and/or various operators, etc. during the control of one or more industrial processes. The historian 114 includes any suitable structure for storing and facilitating retrieval of information such as a volatile and/or non-volatile memory. Although shown as a single component here, the historian 114 could be located elsewhere in the system 100, or multiple historians could be distributed in different locations in the system 100.

Although FIG. 1 shows one example of the industrial process control and automation system 100, it will be appreciated that various changes may be made. For example, the control and automation system 100 may include any number of sensors, actuators, controllers, servers, networks, operator stations, operator consoles, control rooms, networks, and other components. Also, the makeup and arrangement of the system 100 in FIG. 1 is for illustration only. Components may be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment of an industrial plant where system operations done by the various personnel can be monitored. This functionality can be used in any other suitable system, and that system need not be used for industrial process control and automation.

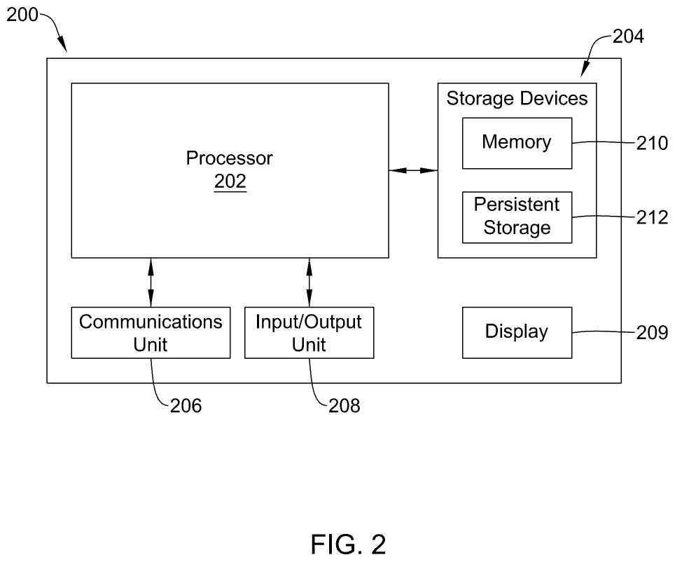

FIG. 2 illustrates an example computing device for enhanced incident tracking, analytics, and remediation. In particular, FIG. 2 illustrates an example computing device 200. In some embodiments, the computing device 200 could denote an operator station, server, a remote server or device, or a mobile device. The computing device 200 could be used to run applications. The computing device 200 could be used to perform one or more functions, such as collecting information, sorting and analyzing the information as well as generating a report of the analysis, and/or initiating remediation of an occurrence of an incident, etc. For ease of explanation, and the computing device 200 are described as being used in the system 100 of FIG. 1, although the computing device 200 could be used in any other suitable system (whether or not related to industrial process control and automation).

As shown in FIG. 2, the computing device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) configured to store and facilitate retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read-only memory, hard drive, flash memory, or optical disc.

The communications unit 206 supports communications with other systems or devices. For example, the communications unit 206 could include at least one network interface card or wireless transceiver facilitating communications over at least one wired or wireless network (such as a local intranet or a public network like the Internet). The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display such as a display 209, printer, or other suitable output device.

The display 209 allows at least output of data. In some instances, the display 209 corresponds to a monitor. In some embodiments, the display 209 corresponds to a touch screen display that allows input and output of data.

Although FIG. 2 illustrates example computing device 200 capable of facilitating or otherwise performing at least some aspects of enhanced incident tracking, analytics, and incident remediation may be made to FIG. 2. For example, various components in FIG. 2 could be combined, further subdivided, or omitted, and additional components could be added according to particular needs. As a particular example, processor 202 can be divided into multiple processors (e.g., hardware processors), such as one or more central processing units (CPUs) and one or more graphics processing units (GPUs). Also, computing device 200 can come in a wide variety of configurations, and FIG. 2 does not limit this disclosure to any particular computing device or mobile device.

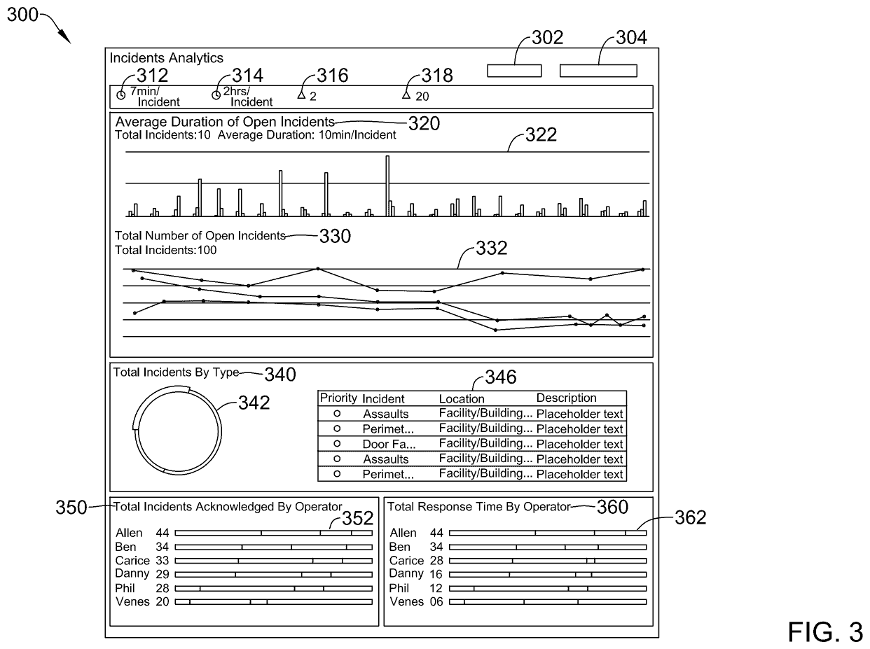

FIG. 3 is an example of a graphical user interface 300 for enhanced incident tracking, analytics, and remediation. The graphical user interface 300 can be included in or displayed by a computing device such as the computing device 200, as described herein with respect to FIG. 2. The information displayed in the graphical user interface 300 can correspond to or be based on information associated with a plurality of incidents at one or more sites for a time period. The time period and/or the one of more sites can be selectable. For instance, both the time period and the one or more sites can be selectable via a dropdown menu (e.g., a dropdown menu 302 which corresponds to one or more selectable sites and a dropdown menu 304 which corresponds to a selectable time period) or can otherwise be selected (e.g., by a site supervisor). Thus, the information displayed via the graphical user interface 300 can be tailored to a particular time period (e.g., a day, a week, a month, a year, all time, etc.) and one or more sites (e.g., an individual site, a collection of some but not all sites, or all sites, etc.). For example, as illustrated in FIG. 3 the information generated for display in the graphical user interface 300 corresponds to incidents in “All Facilities” (e.g., as selected via the dropdown menu 302) over a time period that is the “Last 24 Hours” (e.g., as selected via the dropdown menu 304).

As mentioned, the graphical user interface 300 can display a plurality of visual (e.g., graphical) representations. For example, the visual representations can include visual representations of a plurality of closed (e.g., historical) incidents and real-time visual representations of a plurality of open (e.g., active) incidents and real-time visual representations of a plurality of open incidents. In some embodiments, visual representations of a plurality of closed incidents and real-time visual representations of a plurality of open incidents can be displayed concurrently via the graphical user interface 300, as detailed herein.

In some embodiments, the graphical user interface 300 can be configured to display aggregated information of the plurality of closed incidents and/or the plurality of open incidents. For instance, the graphical user interface 300 can display a summary 310 which includes aggregated information pertaining to the plurality of closed incidents and/or the plurality of open incidents. The summary 310 can pertain to all incidents (e.g., all open incidents and/or all closed incidents) for the selected time period and selected site(s) or can pertain to a subset thereof. For instance, a subset of the closed incidents or open incidents can be a portion of the closed incidents and/or open incidents that are associated with a particular operator (e.g., that was assigned to address an open incident), a particular site or other location (e.g., a room or other portion of a site), a particular time period, and/or a particular type of incident (e.g., a security incident, a weather incident, etc.).

In some embodiments, the summary 310 can include information or visual representations of an average closure time associated with the incidents for the selected time period and the selected site(s). For instance, the summary 310 can include a visual representation or information indicative of an average time that it took to close (e.g., remediate) the closed incidents for the selected period of time and selected site(s), as indicated at 314. The closure time can correspond to a time from when the incident was opened and/or acknowledged until a time that the incident was remediated (e.g., resolved). In some embodiments, the summary 310 can include information or visual representations of an average time to initially respond to the incidents, as indicated at 312, among other possible information. For example, the summary 310 can display an average closure time (e.g., 2 hours/incident), an average response time (e.g., 7 minutes/incident) for an operator to initially acknowledge each of the open and/or closed incidents, among other information, for each of a plurality of incidents across all sites for the selected time period (e.g., the last 24 hours).

Thus, the aggregated information in the summary 310 (or that is otherwise displayed) can include an average closure time of each of the plurality of closed incidents, each of the plurality of open incidents, of both. For instance, the aggregated information in the summary 310 can display an average closure time associated with at least each of the plurality of closed incidents. In some embodiments, the aggregated information in the summary 310 (or that is otherwise displayed) can include an average closure time of each of the plurality of closed incidents, a total quantity of each of the plurality of closed incidents and the plurality of open incidents, a total quantity of each type of the plurality of closed incidents and the plurality of open incidents, or any combination thereof. For instance, in some embodiments, the graphical user interface 300 can be configured to concurrently display aggregated information includes an average closure time of each of the plurality of closed incidents, a total quantity of each of the plurality of closed incidents and the plurality of open incidents, and a total quantity of each type of the plurality of closed incidents and the plurality of open incidents, as detailed herein. These are merely examples and the summary 310 can include other aggregated information from the plurality of open and/or the plurality of closed incidents.

For example, in some embodiments the summary 310 can include visual representations of various incident issue thresholds and visual representations of a quantity of any actual issues with incident resolution that correspond thereto. That is, incident thresholds herein may represent a threshold quantity of occurrences of incidents or issues pertaining to incident resolution. The incident thresholds can be configured for a given time period such as a selected time period (e.g., last 24 hours). In this way, a site manager or other individual can define a target quantity of occurrences of incidents or issues pertaining to incident resolution that may be deemed acceptable and can readily compare (e.g., in real-time) the presence of any actual issues with incident resolution to the various incident thresholds.

For example the summary 310 can include visual representations of a threshold quantity (e.g., 10 or less) of code inconsistencies and an actual quantity of code inconsistencies (e.g., 2 occurrences of code inconsistences) associated with the open and/or closed incidents for the selected time period, as indicated at 316 in FIG. 3. As used herein, a code inconsistency refers to a deviation from a code in a standardized workflow, for instance, when an operator utilizes a code not included in a standardized workflow for a given incident (e.g., for a given type of incident and/or a given site in which the incident occurred, etc.). Similarly, the summary 310 can include visual representations of a threshold quantity (e.g., 20 or less) of repeat incidents and an actual quantity of repeat incidents (e.g., 20 occurrences of the same incident type) associated with the open and/or closed incidents for the selected time period, as indicated at 318 in FIG. 3. As used herein, repeat incidents refer to the presence of at least two of the same incident type within the selected time period. The repeat incidents may occur at the same site or may occur at any one of the selected sites.

In some embodiments, the graphical user interface 300 can be configured to display an average duration of open incidents and/or a total quantity of open incidents for the selected time period and the selected site(s). For instance, the average duration of open incidents can be displayed for a plurality of incident priority levels (e.g., urgent, high, and low priority) as a graph and/or trend line for the selected time period and the selected sites, as indicated at 320. For example, as illustrated in FIG. 3 at 322, the trend of the average duration of the open incidents is shown in graphical form, for instance, as vertical bars representing the duration of the open incidents at different times throughout the selected time period (e.g., at each hour during the last 24 hours). Further, the bars representing the duration of open incidents include a breakdown (e.g., respective bars) of those incidents by priority level (e.g., how many of those incidents are urgent, high, and low priority).

In some embodiments, the graphical user interface 300 can be configured to display a quantity of open incidents for the selected time period and the selected site(s), as illustrated at 330. For example, as illustrated in FIG. 3 at 332, the trend of the total quantity (number) of open incident is shown as continuous lines representing the number of open incidents at the site throughout the different point in time during the selected time period (e.g., at each hour during the last 24 hours). Further, the continuous lines representing the number of open incidents at the site throughout the different point in time during the selected time period include a breakdown (e.g., respective continuous lines) of those incidents by priority level (e.g., how many of those incidents are urgent, high, and low priority).

In some embodiments, the graphical user interface 300 can be configured to display a visual representation of a quantity of different types of occurrences of the open and/or closed incidents during the selected time period at the selected site(s), as indicated at 340. For example, as illustrated in FIG. 3 at 342, text indicative of a total quantity of incidents (e.g., 10 incidents) along with text indicative of a breakdown of respective types of incidents (e.g., 2 assaults, 5 perimeter breaches, and 3 door forces incidents, etc.) can be displayed. Alternatively or additionally, a chart such as a pie chart or type of chart can be displayed to indicate the total quantity of incidents (e.g., 10 incidents) along with a breakdown of respective types of incidents (e.g., 2 assaults, 5 perimeter breaches, and 3 door forces incidents, etc.) can be displayed.

In some embodiments, the graphical user interface 300 can be configured to display a visual representation of a quantity of different types of occurrences of the open and/or closed incidents during the selected time period at the selected site(s), as indicated at 340. For example, as illustrated in FIG. 3 at 342. In some embodiments, the graphical user interface 300 can be configured to display additional details corresponding to some or all of the occurrences of the incidents (e.g., open and/or closed incidents) during the selected time period at the selected site(s), as indicated at 346. For instance, for each occurrence of an incident the corresponding incident priority (e.g., a low priority, a high priority, or an urgent priority), type of incident (e.g., an assault, perimeter breach, door forced, etc.), location of the incident (e.g., a site location and/or a location within a site), and/or a description of the incident (e.g., as represented by placeholder text that can be customized to a particular incident) can be displayed via the graphical user interface.

In some embodiments, the graphical user interface 300 can be configured to display a visual representation of various operator performance metrics. For instance, the graphical user interface 300 can be configured to display a total quantity of incidents acknowledged by an operator during the selected time period at the selected site(s), as indicated at 350. For example, a total quantity of incidents acknowledged by some or all operators associated with one or more selected sites during the selected time period can be displayed via the graphical user interface 300. As illustrated in FIG. 3 at 352, quantity of incidents acknowledged by a plurality of operators (e.g., Allen, Ben, Carice, Danny, Phil, and Vanessa) associated with the selected sites can be displayed in graphical form, for instance, as horizontal bars representing a total quantity of incidents (e.g., open and/or closed incidents) for the selected time period and the selected site(s). Further, the bars representing the quantity of incidents acknowledged can include a breakdown (e.g., respective bars or sub-bars) of those incidents by priority level (e.g., how many of those incidents are urgent, high, and low priority).

In some embodiments, the graphical user interface 300 can be configured to display an average response time (e.g., to initially acknowledge each incident) for each operator during the selected time period at the selected site(s), as indicated at 360. For example, an average response time of incidents acknowledged by some or all operators associated with one or more selected sites during the selected time period can be displayed via the graphical user interface 300. As illustrated in FIG. 3 at 362, an average response time of a plurality of operators (e.g., Allen, Ben, Carice, Danny, Phil, and Vanessa) associated with the selected sites can be displayed in graphical form, for instance, as horizontal bars representing an average response time to the incidents (e.g., open and/or closed incidents) for the selected time period and the selected site(s). Further, the bars representing the average operator response time can include a breakdown (e.g., respective bars or sub-bars) of those incidents by priority level (e.g., how many of those incidents are urgent, high, and low priority).

In some embodiments, the actual (e.g., real-time) average response time (e.g., an aggregated average response time to all incident types and/or an average response time to a particular type of incident such as urgent incidents) can have a corresponding operator response threshold displayed. Similarly, in some embodiments, the actual (e.g., real-time) quantity of incidents acknowledged by an operator (e.g., a total quantity of incidents and/or a quantity of incidents of a particular type of incident such as urgent incidents) can have a corresponding operator acknowledgement threshold displayed. In such instances, displaying the actual (real-time) average operator performance (e.g., actual operator response time) along with a corresponding threshold (e.g., target) can permit a site manager or other individual and/or the computing device displaying the graphical user interface 300 to readily ascertain whether or not a particular operator is performing satisfactorily (e.g., has an average operator response time that is less than or equal to the threshold operator response time). If it is determined that an individual operator is not performing satisfactorily, the individual (e.g., a site manager) and/or the computer displaying the graphical user interface 300 can initiate a remediation action (e.g., assign the operator to take additional training, etc.). For instance, in some embodiments the computer displaying the graphical user interface 300 can be configured to automatically (in an absence of a user input) initiate a remediation action (e.g., assign additional training, etc.) to one or more operators that are not performing satisfactorily.

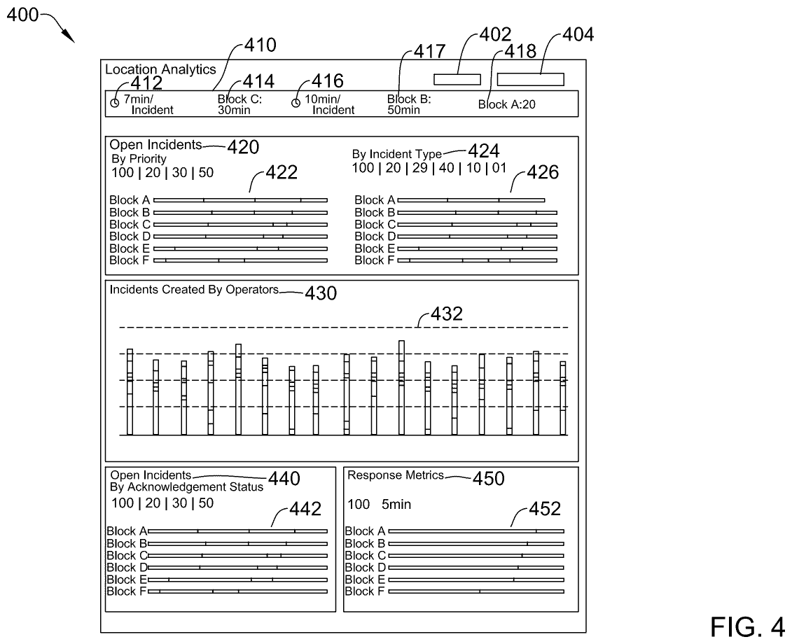

FIG. 4 is an example of a graphical user interface 400 for enhanced incident tracking, analytics, and remediation. The graphical user interface 400 can be included or displayed by a computing device such as the computing device 200, as described herein with respect to FIG. 2. The information displayed in the graphical user interface 400 can correspond to or be based on information associated with a plurality of incidents at one or more sites for a time period. Similar to the graphical user interface 300, the time period and the one or more sites can be selectable via a dropdown menu (e.g., a dropdown menu 402 which corresponds to one or more selectable sites and a dropdown menu 404 which corresponds to a selectable time period) or can otherwise be selected (e.g., by a site supervisor). Thus, the information displayed via the graphical user interface 400 can be tailored to a particular time period (e.g., a day, a week, a month, a year, all time, etc.) and one or more sites (e.g., an individual site, a collection of some but not all sites, or all sites, etc.). For example, as illustrated in FIG. 4 the information generated for display in the graphical user interface 400 corresponds to incidents in “All Facilities” (e.g., as selected via the dropdown menu 402) over a time period that is the “Last year” (e.g., as selected via the dropdown menu 404). The “Last year” can refer to the last (previous) calendar year or the last (previous) 365 days.

In some embodiments, the graphical user interface 400 can be configured to display aggregated information (e.g., for all selected sites) for the selected time period. The aggregated information can include a summary 410 which includes information or visual representations of an average operator acknowledgement time (e.g., to initially acknowledge an incident) and/or an average closure time associated with the incidents for the selected time period and the selected site(s). For instance, the summary 410 can include a visual representation or information indicative of an average acknowledgement time (e.g., 7 minutes/incident) and an average resolution time (e.g., 10 minutes/incident) for the selected period of time and selected site(s), as indicated at 412 and 414, respectively.

In some embodiments, the summary 410 can include information or visual representations of a worst acknowledgement time and/or a worst resolution time. The worst acknowledgement time and/or a worst resolution time can be specific to a particular type of incident, a particular operator, and/or a particular site or location within a particular site. For instance, the summary 410 can include a worst acknowledgement time and/or a worst resolution time associated with a region or block within a particular site. For example, a worst acknowledgement time (e.g., 10 minutes) for an operator to acknowledge an occurrence of an incident of each of a plurality of occurrences of instances at Block C within a site can be displayed, as indicated at 416. Similarly, a worst resolution time (e.g., 50 minutes) for an occurrence of an incident at Block B can be displayed, as indicated at 418. In some embodiments, a total quantity of a type of incident at a site or region (e.g., block) within the site can be displayed. For instance, a total quantity (e.g., 20) of occurrences of high priority incidents can be displayed, as indicated at 418. In such instances, a threshold quantity (e.g., 15) of occurrences of the particular type (e.g., high priority) of incident can be displayed. Display of the actual (e.g., real-time) occurrence of the total quantity of a particular type of incident at the site or region within the site along with (e.g., concurrently with) the corresponding threshold quantity of incidents can permit a site manager or individual to readily ascertain whether or not a remediation measure is needed for the site or region (e.g., block) within the site. In some instances, when the total quantity of the actual (e.g., real-time) occurrence of the total quantity of a particular type of incident at the site or region within the site along with (e.g., concurrently with) exceeds the corresponding threshold quantity of incidents a computing device such as those described herein can automatically initiate a remediation such as one or more of the remediations described herein. These are merely examples and the summary 410 can include other aggregated information from the plurality of open and/or the plurality of closed incidents.

In some embodiments, the graphical user interface 400 can be configured to display a quantity of open incidents and/or a quantity of closed incidents. For example, as illustrated in FIG. 4 at 420, a total quantity of open incidents (e.g., 100 total incidents) can be displayed (e.g., in numerical form and/or as text, etc.). The display can include a breakdown of the total quantity of open incidents. For example, the total quantity of incidents can be broken down based on a particular type of open incident (e.g., 20 urgent incidents, 30 high priority incidents, and 50 low priority incidents). Alternatively or additionally, the total quantity of incidents can be shown in graphical form, for instance, as horizontal bars representing the total quantity of open incidents at different locations (e.g., Block A, Block B, Block C, Block D, Block E, and Block F) in a site. Further, the bars representing the total quantity of open incidents can include a breakdown (e.g., respective bars or sub-bars) of those incidents by priority level (e.g., how many of those incidents are urgent, high, and low priority).

In some embodiments, the graphical user interface 400 can be configured to display a visual representation of a quantity of different types of occurrences of the open and/or closed incidents during the selected time period at the selected site(s). For instance, the graphical user interface 400 can be configured to display particular types of open incidents during the selected time period at the selected site(s), as indicated at 424. For example, as illustrated in FIG. 4 at 426, text indicative of a total quantity of incidents (e.g., 100 incidents) along with text indicative of a breakdown of respective types of incidents (e.g., 20 perimeter breaches, 29 assaults, 40 riot incidents, 10 door forced incidents, and 1 duress incident, etc.) can be displayed. Alternatively or additionally, the quantity of the respective incident types can be shown in graphical form, for instance, as horizontal bars representing the respective incident types of the open incidents at different locations (e.g., Block A, Block B, Block C, Block D, Block E, and Block F) in a site. Further, the bars representing the total quantity of open incidents can include a breakdown (e.g., respective bars or sub-bars) of those incidents by incident type (e.g., how many of those incidents are perimeter incidents, etc.).

As mentioned, in some embodiments, the graphical user interface 400 can be configured to display a visual representation of various operator performance metrics. For instance, in some embodiments, the graphical user interface 400 can be configured to display a visual representation of a quantity of incidents (e.g., open and/or closed incidents) created by one or more operators during the selected time period at the selected site(s). For instance, the graphical user interface 400 can be configured to display a quantity of incidents (e.g., 100 incidents) created during the selected time period at the selected site(s), as indicated at 430. In some embodiments, the total quantity of incidents created by the one or more operators can include a breakdown (e.g., per site and/or by regions in a site) of the total quantity of incidents. For example, as illustrated in FIG. 4, text indicative of a total quantity of incidents (e.g., 100 incidents) along with text indicative of a region or block (e.g., Block B) within a site that has the highest quantity (e.g., 50 operator created incidents) of the operator created incidents associated therewith can be displayed. Alternatively or additionally, the quantity of operator created incidents can be shown in graphical form, for instance, as vertical bars representing the respective quantity of operator created incidents at different locations (e.g., Block A, Block B, Block C, Block D, and Block E) in a site for increments of time (e.g., each month) for the selected time period, as indicated at 432.

In some embodiments, the graphical user interface 400 can be configured to display a total quantity of open incidents acknowledged by an operator for a site or various regions or block during the selected time period at the selected site(s), as indicated at 440. For example, visual representations of a total quantity of open incidents (e.g., 100 open incidents) acknowledged an operator for different locations (e.g., Block A, Block B, Block C, Block D, and Block E) in a site can be displayed. In some embodiments, visual representations (e.g., text) of a breakdown based on respective priorities (e.g., 20 urgent priority open incidents, 30 high priority open incidents, and 50 low priority open incidents) of the total quantity of open incidents can be displayed. Alternatively or additionally, the quantity of open incidents acknowledged by a plurality of operators for different locations in the site can be displayed in graphical form, for instance, as horizontal bars representing a total quantity of open incidents acknowledged for the selected time period and the selected site(s), as indicated at 442. Further, the bars representing the quantity of open incidents acknowledged can include a breakdown (e.g., respective bars or sub-bars) of those incidents by priority level (e.g., how many of those incidents are urgent, high, and low priority).

In some embodiments, the graphical user interface 400 can be configured to display an average response time (e.g., to initially acknowledge each incident) for each operator during the selected time period at the selected site(s). For example, an average response time (e.g., 5 minutes) associated with the total quantity of open incidents acknowledged by some or all operators associated with different locations (e.g., Block A, Block B, Block C, Block D, and Block E) in the site during the selected time period can be displayed via the graphical user interface 400, as indicated at 450. As illustrated in FIG. 4 at 452, an average response time of a one or more operators associated with different regions (e.g., Block A, Block B, Block C, Block D, and Block E) the selected sites can be displayed in graphical form, for instance, as horizontal bars representing an average response time to the incidents (e.g., open and/or closed incidents) for the selected time period and the selected site(s).

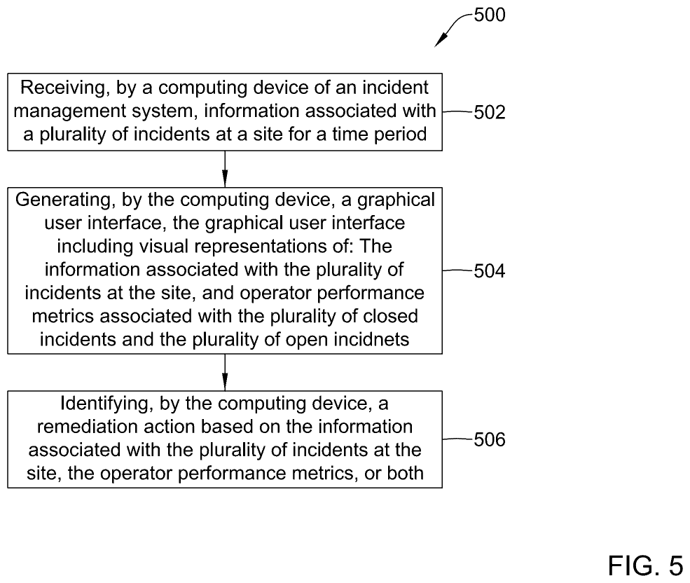

FIG. 5 is a flow diagram showing an illustrative method 500 for enhanced incident tracking, analytics, and remediation. At 502, the method 500 includes receiving, by a computing device (e.g., computing device 200 as described with respect to FIG. 2) of an incident management system, information associated with a plurality of incidents at a site for a time period. The plurality of incidents can be received continuously, periodically (e.g., each minute, each hour, etc.), and/or can be received responsive to an input (e.g., responsive to detection of an occurrence of an incident by the incident management system and/or responsive to an input by a site supervisor to a computing device such as the computing device 200, as described with respect to FIG. 2).

In some embodiments, the method 500 can include receiving information associated with an operator's management of the plurality of incidents (e.g., where each respective incident is managed by the operator using a standard operating procedure associated with that incident). In such embodiments, the method 500 can include analyzing, by the computing device, the operator performance in managing the number of incidents and providing a visual representation of the analysis of the operator performance to a user via the graphical user interface, as detailed herein. For instance, the analysis can include or is based on a key-performance indicator (KPI) associated with operator and/or one or more of each respective incident managed by the operator. For example, the analysis can include comparing the operator performance to a threshold, as detailed herein, and based on the comparison providing a KPI that is specific to the particular operator. Thus, the approaches herein can readily, and in some instances automatically, generate KPI of the operation using one or more stand operating procedures associated with one or more incidents.

At 504, the method 500 can include generating, by the computing device, a graphical user interface, the graphical user interface including various visual representations. For instance, the graphical user interface can include visual representations of the information associated with the plurality of incidents at the site, where the visual representations included visual representations of a plurality of closed incidents and real-time visual representations of a plurality of open incidents; and operator performance metrics associated with the plurality of closed incidents and the plurality of open incidents. For example, the visual representations can include generating and concurrently displaying visual representations of a plurality of closed incidents and real-time visual representations of a plurality of open incidents and operator performance metrics associated with the plurality of closed incidents and the plurality of open incidents. In some embodiments, the visual representations can include visual representations of corresponding thresholds such as corresponding thresholds (e.g., targets or limits) associated with the plurality of open incidents and/or thresholds associated with various operator performance metrics, as detailed herein.

At 506, the method 500 can include identifying, by the computing device, a remediation action based on the information associated with the plurality of incidents at the site, the operator performance metrics, or both. Identifying the remediation action can include identifying whether or not a remediation actions is needed (e.g., based on comparison of actual metrics or performance information to a corresponding threshold, as detailed herein). In some instances, identifying the remediation action can include identifying a particular remediation action from a plurality of possible remediation actions. For instance, the particular remediation action can be identified based on a deviation from a threshold, a degree of deviation from a threshold, a location of one or more incidents, a particular site associated with the one or more incidents, operator performance, a type of one or more incidents, a quantity of incidents, among other criteria.

In some embodiments, the identification can occur by a site manager or other individual, for instance, based on comparison of various visual representations displayed in the graphical user interface. For instance, visual representations of actual (real-time) quantities and/or types of a plurality of closed incidents and/or real-time visual representations of quantities and/or a type of a plurality of open incidents can be readily compared to visual representations of thresholds corresponding thereto. Similarly, visual representations of actual (real-time) operator performance metrics associated with the plurality of closed incidents and the plurality of open incidents can be readily compared by the site supervisor or other individual to corresponding thresholds (e.g., indicative of expected operator responsiveness and/or an expected quantity of incidents acknowledged and/or resolved by an individual operator). Thus, the site supervisor or other individual, due at least in part to the information displayed via the systems and devices herein, can readily compare actual (real-time) information of the incidents and/or related operator performance to thresholds to determine when a remediation actions is needed and which particular remediation action is initiated (e.g., to ensure that the site continues to operate as intended).

However, in some embodiments the identification can occur automatically in the absence of an input by a site supervisor or other individual. For instance, one or more of the computing devices described herein (e.g., the computing device 200 described with respect to FIG. 2) can automatically identify a remediation action. For instance, the computing device can compare information indicative of actual (real-time) quantities and/or types of a plurality of closed incidents and/or real-time visual representations of quantities and/or a type of a plurality of open incidents to thresholds corresponding thereto. Similarly, the computing device can compare information indicative of actual (real-time) operator performance metrics associated with the plurality of closed incidents and/or the plurality of open incidents to corresponding thresholds (e.g., indicative of expected operator responsiveness and/or an expected quantity of incidents acknowledged and/or resolved by an individual operator). Thus, the computing device can compare actual (real-time) information of the incidents and/or related operator performance to thresholds to automatically determine when a remediation actions is needed and which particular remediation action is initiated (e.g., to ensure that the site continues to operate as intended). The automatic comparison can occur continuously, periodically, and/or responsive to an input such as responsive to a detected occurrence of an incident.

Examples of remediation actions include altering a priority of an open incident, designating an operator for training, based on the operator performance metrics, and/or designating a standard operating procedure for review. These are merely examples and other remediation actions such as altering one or more set point of equipment, altering equipment, altering a priority associated with an incident, altering an alarm sequence, and/or altering a type and/or quantity of alarms, etc. are possible.

In some embodiments, the remediation action comprises altering a priority of an open incident of the plurality of open incidents. In some embodiments, altering the priority of an open incident can occur automatically. For instance, when the open incident has been open (is unresolved) for an amount of time that exceeds a threshold (e.g., a threshold amount of time) a priority of the open incident is altered (e.g., is automatically altered). The threshold can be based on an incident type, the incident priority, or both. For example, a low priority incident may have a corresponding threshold (e.g., an acknowledgement threshold and/or a resolution threshold) that is longer than another resolution threshold corresponding to a high priority or urgent priority incident. In some embodiments, a priority of the open incident (which has been open or remains unacknowledged for a time that exceeds a corresponding threshold) can be altered from a first priority (e.g., a high priority) to a second priority (e.g., an urgent priority) that is higher than the first priority. Such alteration (increasing) of the priority can increase a likelihood that the incident is timely addressed subsequent to alteration of the priority.

In some embodiments, the remediation action further comprises designating an operator for training, based on the operator performance metrics. In some embodiments, designating the operator for training can occur automatically. The operator can be designated for training (e.g., to take a course, train in an incident simulator, or otherwise review material related to one or more incidents and/or standardized incident response procedure, etc.) that is specific to a particular type of incident, a particular site, and/or a particular standardized incident response procedure. That is, the training can be tailored to a particular area (e.g., responsiveness to acknowledge incidents, effectiveness of incident resolution, etc.) in which the operator did not meet a particular threshold.

In some embodiments, the remediation action further comprises designating a standard operating procedure, a threshold (e.g., a resolution threshold), or both for review. For instance, a standard operating procedure that repeatedly results in incident resolution times which exceed a threshold and/or which result in repeated occurrences of the same type of incident in the same location over a period of time can lead to the standard operating procedure (alone or along with the threshold corresponding thereto) to be designated for review. In some embodiments, designating the standard operating procedure, a threshold, or both can be designated for review automatically.

In some embodiments, the method 500 can include initiating a remediation action. For instance, the method 500 can include automatically initiating a remediation action via the computing devices herein (e.g., the computing device 200 as described in FIG. 2). Examples of automatically initiating a remediation action can include a computing device automatically transmitting a signal or altering a status (e.g., a flag, an alarm, etc.) to cause an initiation or occurrence of a remediation action.

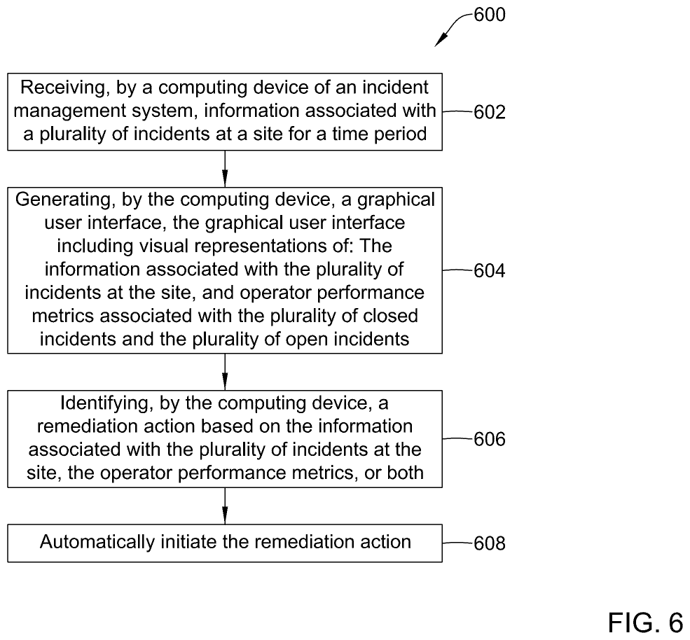

FIG. 6 is a flow diagram showing an illustrative method 600 for enhanced incident tracking, analytics, and remediation. At 602, the method 600 can include receiving, information associated a plurality of incidents at a site for a time period, as described herein. At 604, the method 600 can include generating a graphical user interface that is configured to be displayed via the display, as described herein. For instance, the visual representations can include visual representation of the information associated with the plurality of incidents at the site, where the visual representations included representations of a plurality of closed incidents and real-time representations of a plurality of open incidents; an operator performance metrics associated with the plurality of closed incidents and the plurality of open incidents, as described herein. At 606, the method 600 can include identifying a remediation action based on the information associated with the plurality of incidents at the site, the operator performance metrics, or both, as described herein. At 608, the method 600 can include automatically initiating the remediation action, as described herein.

In some embodiments, the methods 500/600 can include displaying a visual representation of a status of the remediation action. For instance, the via a graphical user interface such as those described herein. For example, the visual representation of the status of the remediation action can be displayed concurrently with visual representations of: the information associated with the plurality of incidents at the site, where the visual representations included representations of a plurality of closed incidents and real-time representations of a plurality of open incidents; and operator performance metrics associated with the plurality of closed incidents and the plurality of open incidents. Thus, the systems, devices, and methods herein can permit identification of remediation actions based on actual (real-time information) and can provide visual representations of actual (real-time) information indicative of a status of on-going remediations, thereby providing site managers with an enhanced wholistic vantage of various aspects pertaining to building management. For instance, in some embodiments, the methods 500/600 herein can display a visual representation of a total quantity and/or type of completed remediation actions, display a visual representation of a total quantity and/or type of pending (yet to be completed) remediation actions, or both. In some embodiments, the visual representations of the status of the remediation action can be specific to the site, specific to one or more operators associated with the site, or both.

Aspects of the illustrative methods herein can be performed with or via one or more of the components described herein. For instance, the illustrative methods herein can be performed in conjunction with or by at least a computing device (e.g., computing device 200), among other possible components.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for enhanced incident management, the method comprising:
receiving, by a computing device of an incident management system, information associated with a plurality of incidents at a site for a time period;
generating, by the computing device, a graphical user interface, the graphical user interface including visual representations of:
the information associated with the plurality of incidents at the site, wherein the visual representations included visual representations of a plurality of closed incidents, real-time visual representations of a plurality of open incidents, or both; and
operator performance metrics associated with the plurality of closed incidents and the plurality of open incidents; and
identifying, by the computing device, a remediation action based on the information associated with the plurality of incidents at the site, the operator performance metrics, or both.

2. The method of claim 1, wherein the visual representations include a visual representation of a priority of each of the plurality of incidents, and wherein the remediation action comprises altering a priority of an open incident of the plurality of open incidents.

3. The method of claim 2, wherein the open incident has been open for an amount of time that exceeds a threshold, wherein threshold is based on a type, a priority, or both, associated with the open incident, and wherein priority of the open incident is altered from a first priority to a second priority that is higher than the first priority.

4. The method of claim 1, wherein the remediation action further comprises designating an operator for training, based on the operator performance metrics.

5. The method of claim 1, wherein the remediation action further comprises designating a standard operating procedure, a threshold, or both for review.

6. The method of claim 1, further comprising displaying aggregated information of the plurality of closed incidents and the plurality of open incidents.

7. The method of claim 6, wherein the aggregated information includes an average closure time of each of the plurality of closed incidents, a total quantity of each of the plurality of closed incidents and the plurality of open incidents, a total quantity of each type of the plurality of closed incidents and the plurality of open incidents, or any combination thereof.

8. The method of claim 1, further comprising:
receiving information associated with an operator's management of the plurality of incidents, wherein each respective incident is managed by the operator using a standard operating procedure associated with the incident;
analyzing, by the computing device, the operator performance metrics in managing the plurality of incidents; and
providing a visual representation of the analysis of the operator performance metrics to a user via the graphical user interface.

9. The method of claim 8, wherein the analyzing the operator performance metrics includes generating a key-performance indicator (KPI) of the operator using the standard operating procedure associated with the incident.

10. The method of claim 1, further comprising causing, by the computing device, initiation of the remediation action.

11. A computing device for enhanced incident management, the computing device comprising:
a display;
a memory; and
a processor configured to execute executable non-transitory computer readable instructions stored in the memory to:
receive, information associated a plurality of incidents at a site for a time period;
generate a graphical user interface that is configured to be displayed via the display, the graphical user interface including visual representations of:
the information associated with the plurality of incidents at the site, wherein the visual representations included representations of a plurality of closed incidents and real-time representations of a plurality of open incidents; and
operator performance metrics associated with the plurality of closed incidents and the plurality of open incidents; and
identify a remediation action based on the information associated with the plurality of incidents at the site, the operator performance metrics, or both.

12. The computing device of claim 11, wherein the instructions are executable to concurrently display the information associated with the plurality of incidents at the site and the operator performance metrics associated with the plurality of closed incidents and the plurality of open incidents.

13. The computing device of claim 11, wherein the instructions are executable to select the time period.

14. The computing device of claim 13, wherein the instructions are executable to:
display the information associated with the plurality of incidents at the site for the selected time period and
display the operator performance metrics associated with the plurality of closed incidents and the plurality of open incidents for the selected time period.

15. The computing device of claim 13, wherein the instructions are executable to display a visual of the selected time period concurrently with:
the information associated with the plurality of incidents at the site for the selected time period; and
the operator performance metrics associated with the plurality of closed incidents and the plurality of open incidents for the selected time period.

16. The computing device of claim 11, wherein the site is included in a plurality of sites, wherein the site is selectable, and wherein the instructions are executable to display a visual representation of the selected site concurrently with:
the information associated with the plurality of incidents for the selected site; and
the operator performance metrics associated with the plurality of closed incidents and the plurality of open incidents for the selected site.

17. A non-transitory, computer-readable medium including instructions that when executed by a processor cause the processor to:
receive, information associated a plurality of incidents at a site for a time period;
generate a graphical user interface that is configured to be displayed via the display, the graphical user interface including visual representations of:
the information associated with the plurality of incidents at the site, wherein the visual representations included representations of a plurality of closed incidents and real-time representations of a plurality of open incidents; and
operator performance metrics associated with the plurality of closed incidents and the plurality of open incidents;
identify a remediation action based on the information associated with the plurality of incidents at the site, the operator performance metrics, or both; and
automatically initiate the remediation action.

18. The medium of claim 17, wherein the instructions are executable to display a visual representation of a status of the remediation action.

19. The medium of claim 17, wherein the instructions are executable to display a visual representation of a total quantity and/or type of completed remediation actions, display a visual representation of a total quantity and/or type of pending remediation actions, or both.

20. The medium of claim 19, wherein the visual representation of the status of the remediation action is specific to the site, specific to one or more operators associated with the site, or both.
